(19) United States
(12) Patent Application Publication
(10) Pub. No.: US 2013/0262293 A1
(43) Pub. Date: Oct. 3, 2013

(54) VARIABLE CHARGING OF AUDIENCE MEMBER TEMPORAL VIEWING OF A LIVE VIDEO CHAT PERFORMANCE

(71) Applicant: Robert L. Garner, JR., Miami Beach, FL (US)

(72) Inventor: Robert L. Garner, JR., Miami Beach, FL (US)

(21) Appl. No.: 13/436,396

(22) Filed: Mar. 30, 2012

(51) Int. Cl. G06Q 30/06

(52) U.S. Cl. 705/39

(57) ABSTRACT

A method, system, and computer program product for variable charging is provided. The method can include receiving a request to access a video conference from a computing device of a viewer, calculating an audience size contemporaneously accessing the video conference and varying a rate charged to the viewed according to the calculated audience size. Optionally, the rate can be displayed on the computing device.

### BACKGROUND OF THE INVENTION

1. Field of the Invention

The present invention relates to video chatting over a computer communications network and, more particularly, to end user billing during video chatting.

2. Description of the Related Art

Video conferencing refers to a set of interactive telecommunication technologies that allow two or more locations to interact via two-way video and audio transmissions simultaneously. Generally, videoconferencing works by compressing both the audio and video streams of content using a codec. The encoded audio and video streams are assembled in a container bitstream. The bitstream is then delivered from a streaming server to a streaming client using a transport protocol.

Video chatting is videoconferencing, but video chatting generally refers to videoconferencing done in a non-professional environment, usually among friends. Video chatting brings people at different sites together. Generally, video chatting requires each participant to have a personal computer or other computing device with a video camera or a “webcam.” Originally, a webcam was a separate device, but now it is often built directly into a laptop or a desktop screen. Other devices, including telephones and personal digital assistants (PDAs), also have integrated cameras that can function as webcams. In addition to video chatting among friends, one can use an Internet enabled device, with or without a camera, to watch and/or to listen to live streaming media. Often, the person is charged on a pay-per-view or on a per-minute basis for watching the streaming media.

### BRIEF SUMMARY OF THE INVENTION

Embodiments of the present invention address deficiencies of the art with respect to variable charging and provide a novel and non-obvious method, system, and computer program product for variable charging based on the size of an audience accessing an appearance. In an embodiment of the invention, a method for variable charging is provided. The method can include calculating an audience size accessing a video conference in response to accepting a request to access the video conference from a computing device and varying a rate charged to the viewer according to the calculated audience size.

Another embodiment of the invention provides for a variable rate charging system. The system can include a server coupled to at least one computing device and a variable rate charging module executing in memory of the server. The variable rate charging module can include program code for calculating an audience size accessing a video conference in response to accepting a request to access the video conference from a computing device and varying a rate charged to the viewer according to the calculated audience size.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only, and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention, and, together with the description, serve to explain the principles of the invention. The embodiments illustrated herein are presently preferred; however, it is understood that the invention is not limited to the precise arrangements and instrumentalities shown, wherein:

FIG. 1 is a pictorial illustration of a process for adjusting the rate of accessing an appearance based on the size of the audience watching the appearance;

FIG. 2 is a schematic illustration of a variable rate charging system configured for charging a variable rate for accessing an appearance based on the size of the audience accessing the appearance; and,

FIG. 3 is a flow chart illustrating a process for variable rate charging.

### DETAILED DESCRIPTION OF THE INVENTION

In accordance with an embodiment of the invention, an online video conference can be configured for variable rate charging. Specifically, when engaging in a video conference online, an end user accessing the video conference can be charged an initial rate, for instance on a cost per minute basis, but the rate can vary depending upon a number of other end users participating in the video conference. In one instance, the audience size can be calculated based on the number of computing devices simultaneously streaming the same presentation. Optionally, the rate to be charged for participation in the online video conference can be varied only when the number of participants exceeds a threshold value.

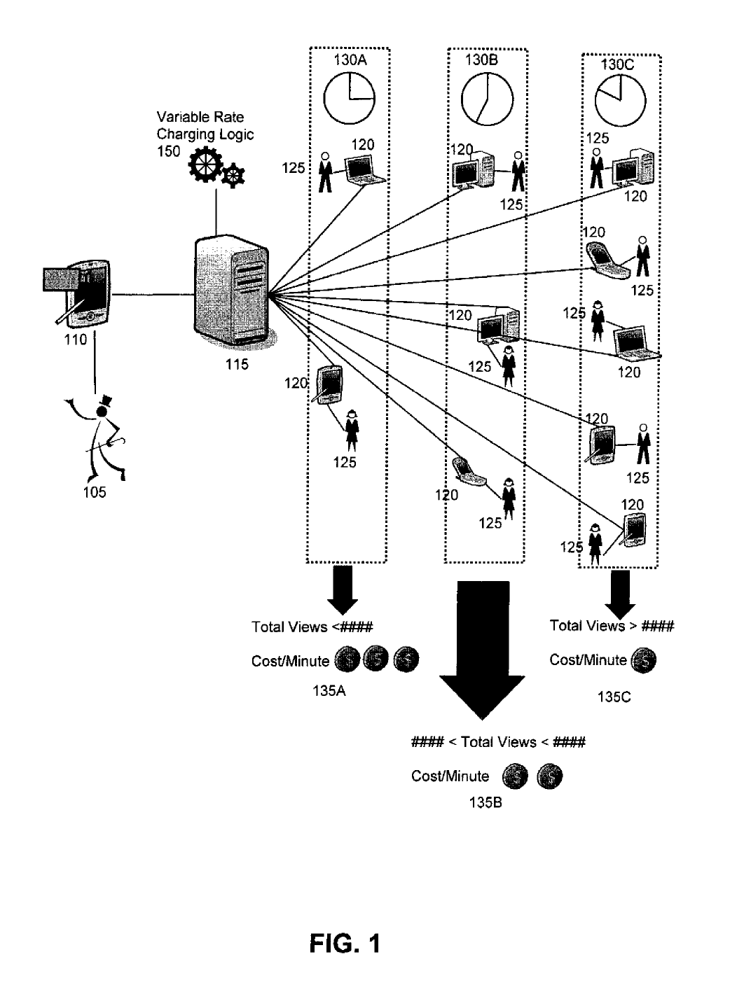

In further illustration, FIG. 1 shows a process for adjusting the rate of accessing an appearance of a performer in a video conference based upon the size of the audience viewing the appearance. As shown in FIG. 1, a performer or a presenter 105, such as a celebrity, can use a camera on a computing device 110 to record and/or stream imagery from an online video conference, such as frames of a presentation by a performer or a presenter 105 providing a live appearance in the online video conference via a server 115. Of note, the presentation can include the presenter 105 answering questions, talking about daily experiences, performing a song, participating in physical exercise, and engaging in online textual messaging with at least one user 125. Further, the performance can be recorded for future playback and/or can be streamed to show live appearances via a server 115.

In response to the presenter 105 recording and/or streaming a presentation or performance, at least one end user 125 on a computing device 120 can access the presentation or performance in order to stream, play, watch and/or listen to the presentation or performance. In this regard, an end user 125 can access the presentation or performance directly through a customized viewer, or via a website from a computing device 120 by way of an access request. Upon receiving an access request, variable rate charging logic 150 on a server 115 can calculate the size of an audience contemporaneously accessing the presentation or performance at a first noted time 130A, for example by determining the number of computing devices simultaneously streaming the identical presentation or performance. In another instance, the initial audience size can be calculated by determining the number of computing devices 120 connected to the sever 115 hosting the presentation or performance.

Upon calculating the audience size at a first noted time 130A, variable rate charging logic 150 can determine whether to vary a rate charged the viewer according to the calculated audience size. In one instance, whether to vary a rate charged the viewer can be determined by whether the calculated audience size meets a threshold value. A different rate for accessing the appearance can subsequently be calculated based upon determining whether the threshold is met. For example, as illustrated in 135A, the rate, such as cost per minute, can be one value, such as one dollar per minute, if the audience size is less than a threshold value, such as one thousand. Optionally, the rate can be displayed on the computing device 120 of an end user 125. Of note, the threshold is not defined as a specific value or values, but can be any value or values, including a range of values. In addition, the threshold can be coded as part of variable rate charging logic 150 or can be coded in such a way as to allow a system administrator or other user to set the threshold, such as through a dialog box.

Optionally, upon the passage of time period 130B, such as ten seconds, variable rate charging logic 150 can recalculate the audience size. The time period is not limited to a specific value; in other words, the time period can vary. Variable rate charging logic 150 can then vary a rate charged depending on whether the recalculated audience size exceeds a threshold value. Of note, the subsequent threshold can be the same value as the prior threshold, or it can be different. The rate can be recalculated by variable rate charging logic 150 upon determining whether the subsequent threshold is met. For instance, as illustrated in 135B, if the audience size is determined to fall within a subsequent threshold, for example between one thousand and one and five thousand, then the cost per minute can be adjusted, such as lowered from the initial rate of one dollar to seventy five cents per minute. In another embodiment, as shown in 135C at some time 130C, if variable rate charging logic 150 determines the audience size is greater than a threshold, for example five thousand and one, the cost per minute of accessing a video conference may drop again, for instance to fifty cents. In other words, the rate charged an end user 125 can continue to be modified as variable rate charging logic 150 determines a threshold is met after calculating the audience size. The recalculated rate can, optionally, be displayed to the computing device 120 of an end user 125. Of note, besides audience size, rates can be affected by a variety of factors, including, but not limited to, whether an end user 125 has any credits and the nature of the video conference itself.

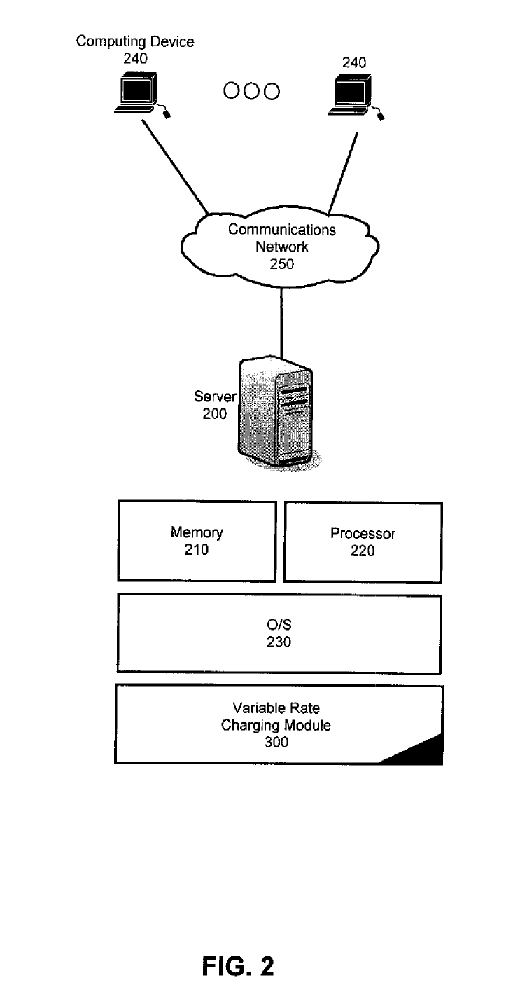

The process described in connection with FIG. 1 can be implemented in a variable rate charging system. In further illustration, FIG. 2 is a schematic depiction of a variable rate charging system configured for charging a variable rate for accessing a video conference based on the size of the audience accessing the video conference. The system can include a server 200. The server 200 can include at least one processor 220 and memory 210. An operating system (O/S) 230 can execute in the memory 210 of the server 200. The O/S 230 can host the operation of a variable rate charging module 300.

The variable rate charging module 300 can include program code that when executed by at least one processor 220 of the server 200 calculates an audience size contemporaneously accessing a video conference in response to receiving a request to access the video conference from a computing device 240 of a viewer. Of note, the video conference can include, but is not limited to a presentation and a streamed performance by a performer. The computing device 240 can send a request seeking permission to access a video conference to the server 200 via a communications network 250. The communication network 250 can include, but is not limited to, communications via the Internet, wireless communications, Ethernet, 3G, and 4G.

Upon calculating the audience size, program code of the variable rate charging module 300 can vary the rate charged to the viewer according to the audience size. Of note, the variable rate charging module 300 can further include program code so the rate can be varied by first determining whether the audience size exceeds a threshold value and subsequently calculating a different rate only if the threshold is met. Optionally, program code can be included that enables the variable rate charging module 300 to display the rate onto a computing device 240.

Optionally, the variable rate charging module 300 can include program code to recalculate the audience size after the passage of a time period. The variable rate charging module 300 can further include program code to determine whether a subsequent threshold is met upon comparing a recalculated audience size to the subsequent threshold. The rate can then be recalculated for accessing the appearance based upon determining that the subsequent threshold is met. The variable rate charging module 300 can further include program code to optionally display the recalculated rate on a computing device 240 of an end user.

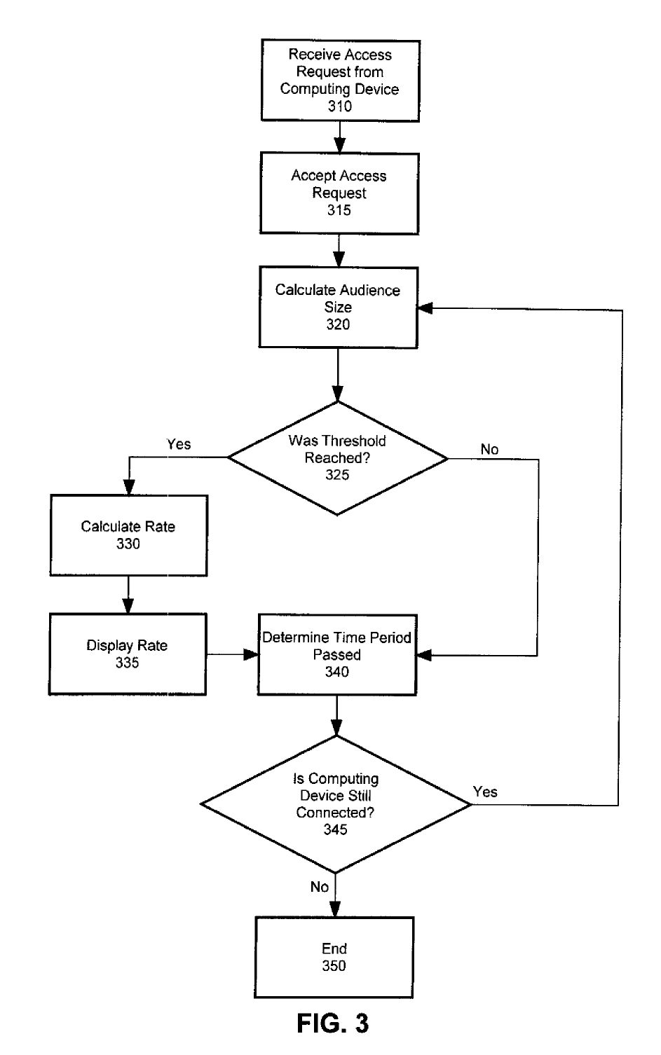

In yet further illustration of the operation of the variable rate charging module 300, FIG. 3 is a flow chart depicting a process for variable rate charging. Beginning in step 310, a request can be received from a computing device of an end user seeking to access a video conference. In step 315, the access request can be accepted. Once an access request from the computing device of an end user is accepted, the size of the audience contemporaneously accessing the requested video conference can be calculated, as shown in step 320. In step 325, a determination can be made as to whether a threshold is met upon comparing the calculated audience size to the threshold. Of note, the threshold is not limited to a specific value. Of further note, the threshold value can be a range of values. Upon a determination that the threshold is met, then a rate, such as cost per minute, can be calculated, as indicated in step 330. The rate can, optionally, be displayed on the computing device of an end user, as in step 335. Optionally, as indicated in step 340, upon determining that a time period has passed, the module can determine whether the computing device is still connected, e.g. still accessing the video conference, as shown in step 345. Of note, determining how the time period has passed is not specifically defined, but can be accomplished by any method now known or later developed. In addition, the time period can be any value; it can also vary, for instance, after each processing loop. Of further note, determining whether the computing device is still contacted can be accomplished by any method now known or later developed.

Once it is determined that the computing device is no longer connected—for instance, no longer accessing the appearance--the process ends, as shown in 350. If the computing device is still connected, the process of calculating the audience size (step 320), determining if a threshold is reached (325), calculating a rate (330), etc. can be repeated until a result forces an end (step 350).

If, at step 325, the threshold is not met, but a time period is determined to have passed (step 340), and the computing device is determined to still be connected (step 345), then the variable rate charging module can again calculate the audience size (step 320) and again determine if a threshold is reached (step 325). The variable rate charging process will continue until an outcome forces an end (step 350). Of note, determining whether a time period has passed and determining whether the computing device is still connected are both optional steps.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied therein.

Any combination of one or more computer readable medium(s) may be utilized. The computer readable medium may be a computer readable signal medium or a computer readable storage medium. A computer readable storage medium may be, for example, but is not limited to, an electronic, magnetic, optical, electromagnetic, infrared, or semiconductor system, apparatus, or device, or any suitable combination of the aforementioned. More specific examples (a non-exhaustive list) of computer readable storage media include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the aforementioned. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the aforementioned. Computer program code for carrying out operations for aspects of the present invention may be written in any combination of one or more programming languages, including an object-oriented programming language and conventional procedural programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only, and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A method for variable charging comprising:
receiving a request to access a video conference from a computing device of a viewer;
calculating an audience size contemporaneously accessing the video conference; and,
varying a rate charged to the viewer according to the calculated audience size.

2. The method of claim 1, wherein the video conference is a presentation.

3. The method of claim 1, wherein the video conference is a streamed performance.

4. The method of claim 1, wherein the rate is varied by first determining whether the audience size exceeds a threshold value and subsequently calculating a different rate only if the threshold is met.

5. The method of claim 1, further comprising:
displaying the rate charged to the viewer onto the computing device of the viewer according to the calculated audience size.

6. A computer program product for variable charging, the computer program product comprising:
a computer readable storage medium having computer readable program code embodied therewith, the computer readable program code comprising:
computer readable program code for receiving a request to access a video conference from a computing device of a viewer;
computer readable program code for calculating an audience size contemporaneously accessing the video conference; and,
computer readable program code for varying a rate charged to the viewer according to the calculated audience size.

7. The computer program product of claim 6, wherein the video conference is a presentation.

8. The computer program product of claim 6, wherein the video conference is a streamed performance.

9. The computer program product of claim 6, wherein the rate is varied by first determining whether the audience size exceeds a threshold value and subsequently calculating a different rate only if the threshold is met.

10. The computer program product of claim 6, further comprises computer readable program code for displaying the rate charged to the viewer onto the computing device of the viewer according to the calculated audience size.

11. A variable rate charging system comprising:
a server with at least one processor and memory;
at least one computing device with at least one processor and memory coupled to the server; and,
a variable rate charging module executing on the server comprising program code to receive a request to access a video conference from a computing device of a viewer, calculate an audience size contemporaneously accessing the video, and to vary a rate charged to the viewer according to the calculated audience size.

12. The system of claim 11, wherein the video conference is a presentation.

13. The system of claim 11, wherein the video conference is a streamed performance by a performer.

14. The system of claim 11, wherein the rate is varied by first determining whether the audience size exceeds a threshold value and subsequently calculating a different rate only if the threshold is met.

15. The system of claim 11, wherein the program code of the variable rate charging module is further enabled to display the rate charged to the viewer onto the computing device of the viewer according to the calculated audience size
